(19) United States
(12) Patent Application Publication
(10) Pub. No.: US 2012/0036530 A1
(43) Pub. Date: Feb. 9, 2012

(54) DIGITAL BROADCAST RECEIVING APPARATUS

(76) Inventor: Yusuke NISHIDA, Osaka (JP)

(21) Appl. No.: 13/193,817

(22) Filed: Jul. 29, 2011

(30) Foreign Application Priority Data
Aug. 5, 2010 (JP) 2010-176381

(51) Int. Cl. H04N 7/025

(52) U.S. Cl. 725/33

(57) ABSTRACT

A digital broadcast receiving apparatus includes: an emergency warning information obtaining unit for receiving a digital broadcast signal and extracting and obtaining emergency warning information from the received digital broadcast signal; a network communication unit for obtaining information on a site related to the emergency by network communication when the emergency warning information obtained by the emergency warning information obtaining unit indicates the occurrence of an emergency; and a display signal generation unit for generating a display signal based on the information on the site obtained by the network communication unit and outputting the display signal to a display unit.

This application is based on Japanese Patent Application No. 2010-176381 filed on Aug. 5, 2010, the contents of which are hereby incorporated by reference.

### BACKGROUND OF THE INVENTION

1. Field of the Invention

The present invention relates to a digital broadcast receiving apparatus and particularly to a process in an emergency such as an earthquake.

2. Description of Related Art

Conventionally, there has been a system for showing a breaking news ticker in television broadcast in an emergency such as an earthquake. To obtain more detailed information, it has been necessary for a user to search a special news program or connect to the Internet.

Accordingly, for example, Japanese Unexamined Patent Publication No. 2005-260646 discloses a broadcast service providing method by which a broadcast service controller transmits data related to a breaking story to a broadcast receiving apparatus via the Internet and the broadcast receiving apparatus displays related information on a monitor based on the received related data. According to this, in an emergency such as an earthquake, a user can obtain detailed information on the emergency in a short time.

Further, an earthquake warning system including an analyzer for estimating the epicenter position and magnitude of an earthquake based on a detection signal from a seismic instrumentation and specifying areas needed to be warned, a warning apparatus for generating and transmitting first earthquake warning information according to an analysis result of the analyzer, a provider server for specifying an IP address of each terminal unit using warning area information included in the input earthquake warning information as a key and generating and transmitting second earthquake warning information to the terminal units of the specified IP addresses, and the terminal units is disclosed, for example, in Japanese Unexamined Patent Publication No. 2001-307265. The terminal units perform a predetermined warning operation based on the received second earthquake warning information and, thereafter, can obtain more detailed information by accessing an earthquake information server.

However, the method disclosed in Japanese Unexamined Patent Publication No. 2005-260646 requires a special apparatus such as the broadcast service controller outside the broadcast receiving apparatus, and the system disclosed in Japanese Unexamined Patent Publication No. 2001-307265 also requires special apparatuses such as the analyzer and the warning apparatus outside the respective terminal units.

### SUMMARY OF THE INVENTION

The present invention aims to provide a digital broadcast receiving apparatus with which, in an emergency, a user can obtain detailed information on the emergency in a short time without requiring a special apparatus outside the receiving apparatus.

The present invention is directed to a digital broadcast receiving apparatus, comprising an emergency warning information obtaining unit for receiving a digital broadcast signal and extracting and obtaining emergency warning information from the received digital broadcast signal; a network communication unit for obtaining information on a site related to the emergency by network communication when the emergency warning information obtained by the emergency warning information obtaining unit indicates the occurrence of an emergency; and a display signal generation unit for generating a display signal based on the information on the site obtained by the network communication unit and outputting the display signal to a display unit.

According to such a construction, when an emergency occurs, a digital broadcast signal including emergency warning information indicating the occurrence of the emergency is received, information on a site related to the emergency is automatically obtained by network communication, and the site related to the emergency is displayed on the display unit. Thus, a user can obtain detailed information on the emergency in a short time without requiring a special apparatus outside the apparatus.

Here, in this construction, the emergency warning information may be disaster warning information. Further, the disaster warning information may be earthquake motion warning information. Thus, in the event of a disaster such as an earthquake, the user can obtain detailed information on the disaster in a short time.

Also, in any one of the above constructions, the information on the site may be information on an SNS (Social Network Service). Further, the information on the SNS may be information on Twitter (registered trademark). This enables detailed information on the emergency posted by network users to be obtained in a short time.

Also, in any one of the above constructions, an updating unit for updating firmware and a URL (Uniform Resource Locator) by downloading firmware including a URL from a network may be further provided, and the network communication unit may obtain the information on the site related to the emergency by accessing the updated URL when the emergency warning information obtained by the emergency warning information obtaining unit indicates the occurrence of the emergency.

According to such a construction, even if the URL of the site related to the emergency has been changed, the URL as an access destination is updated together with the firmware. Thus, the information on the site related to the emergency can be continuously obtained.

Also, in any one of the above constructions, an area detection unit for detecting an area where the apparatus is installed when the emergency warning information obtained by the emergency warning information obtaining unit indicates the occurrence of the emergency may be further provided, and the network communication unit may access a pre-registered site, transmit a keyword corresponding to the detected area for search and obtain searched information on a site related to the emergency when the emergency warning information obtained by the emergency warning information obtaining unit indicates the occurrence of the emergency.

According to such a construction, the area of installation is automatically detected without dependence on the area where the apparatus is installed and a site related to the emergency in the installed area is displayed, wherefore convenience is improved.

### BRIEF DESCRIPTION OF THE DRAWINGS

FIG. 1 is a diagram showing a schematic construction of a digital television according to one embodiment of the present invention,

FIG. 2 is a flow chart relating to an example of an earthquake detection process according to the present invention, and

FIG. 3 is a flow chart relating to another example of the earthquake detection process according to the present invention.

### DETAILED DESCRIPTION OF PREFERRED EMBODIMENTS

Hereinafter, an embodiment of the present invention is described with reference to the drawings. Here, a digital broadcast receiving apparatus of the present invention is described, taking a digital television as an example.

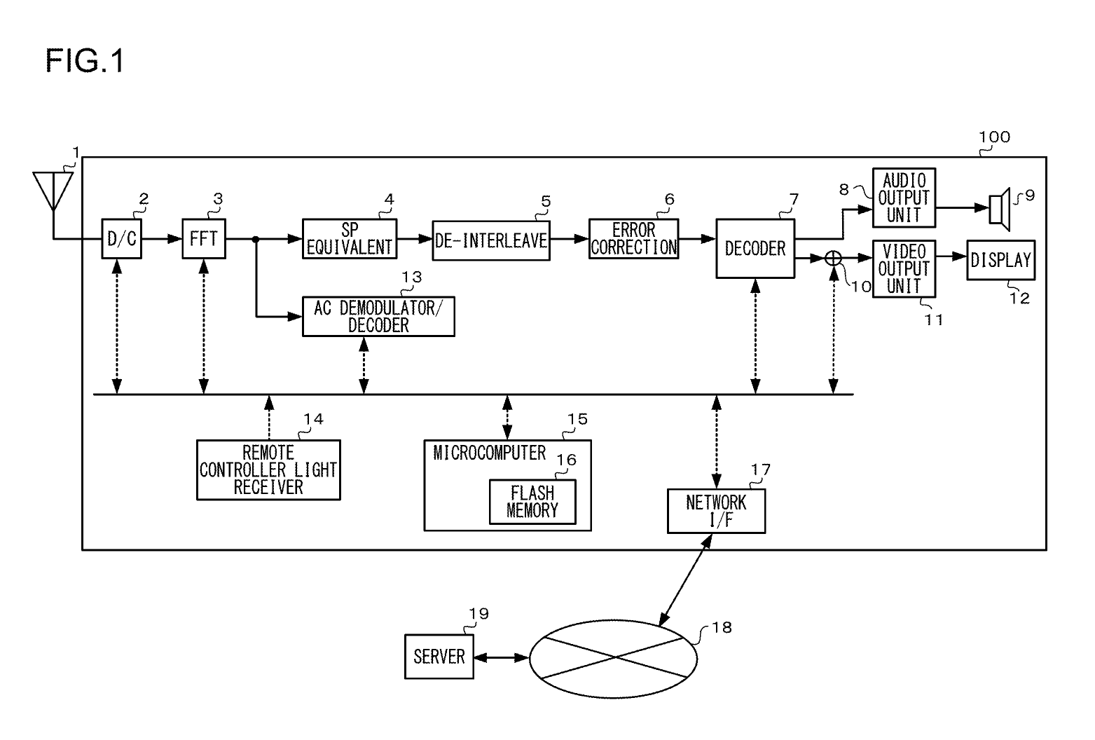

A schematic construction of the digital television according to one embodiment of the present invention is shown in FIG. 1. As shown in FIG. 1, a digital television 100 according to the present invention includes a down converter 2, an FFT (Fast Fourier Transform) demodulator 3, an SP equivalent circuit 4, a de-interleave circuit 5, an error correction circuit 6, a decoder 7, an audio output unit 8, a speaker 9, an OSD (On Screen Display) unit 10, a video output unit 11, a display 12, an AC demodulator/decoder 13, a remote controller light receiver 14, a microcomputer 15, a flash memory 16 and a network OF (network interface) 17, wherein an antenna 1 is connected to the down converter 2.

A terrestrial digital broadcast signal received by the antenna 1 is converted into a baseband OFDM signal in the down converter 2 and an ISDB-T_TS is obtained by demodulation through an FFT process of the FFT demodulator 3. This ISDB-T_TS is restored to an original broadcast TS via the SP equivalent circuit 4, the de-interleave circuit 5 and the error correction circuit 6. The decoder 7 separates video/audio data from the broadcast TS, decodes the separated video/audio data and outputs an audio signal after decoding to the audio output unit 8 and a video signal after decoding to the OSD unit 10.

The audio output unit 8 performs a D/A conversion, a tone control and the like on the input audio signal and outputs the audio signal to the speaker 9 to cause the speaker 9 to output a sound. Further, the OSD unit 10 generates an OSD signal, generates a video signal by superimposing the OSD signal on the video signal input from the decoder 7 and outputs the generated video signal to the video output unit 11. The video output unit 11 converts the input video signal into a display signal suitable for display on the display 12 and outputs the display signal to the display 12. The display 12 is a liquid crystal display, a plasma display or the like and displays a video image based on the input display signal.

The AC demodulator/decoder 13 demodulates/decodes an AC carrier of the ISDB-T_TS to extract an AC signal. The AC signal includes earthquake motion warning information (B17-18 data defined in terrestrial digital broadcast standards ARIB STD-B31).

The remote controller light receiver 14 receives a remote controller signal corresponding to a key operation from an unillustrated remote controller and converts the received remote controller signal into a code signal. The microcomputer 15 performs overall control of the digital television 100 and includes the flash memory 16. The flash memory 16 is a storage device for storing firmware and the like. The network I/F 17 is an interface for performing communication with Internet 18.

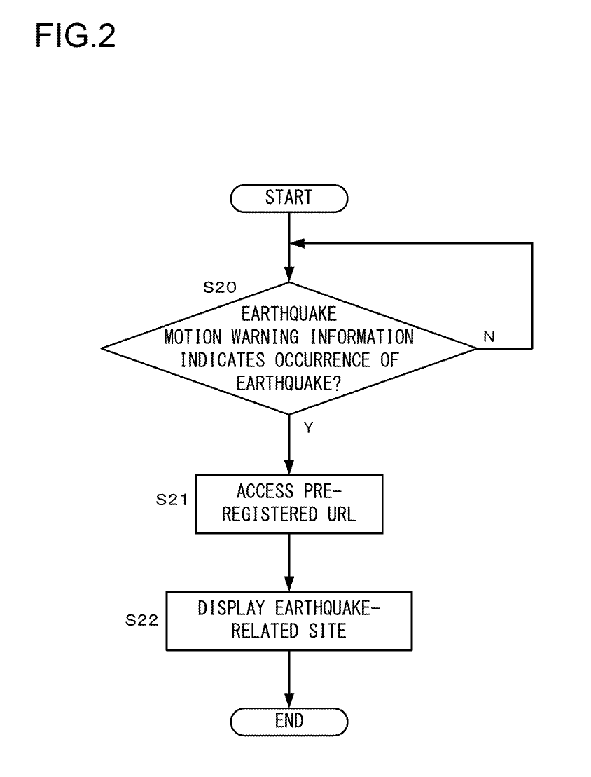

Next, an earthquake detection process of the digital television 100 according to the present invention constructed as described above is described using a flow chart of FIG. 2.

First, in Step S20, the microcomputer 15 determines whether or not the earthquake motion warning information included in the AC signal extracted in the AC demodulator/decoder 13 indicates the occurrence of an earthquake, and determination is continued if no earthquake has occurred (N in Step S20) while a transition is made to Step S21 if an earthquake has occurred (Y in Step S20). The earthquake motion warning information indicating the occurrence of an earthquake is specifically when the B17-18 data is “00”.

In Step S21, the network I/F 17 accesses a server 19 of a URL (Uniform Resource Locator) pre-registered in the flash memory 16 in accordance with an instruction of the microcomputer 15. Then, in Step S22, when obtaining site display data from the server 19 via the network I/F 17, the microcomputer 15 gives an instruction to the OSD unit 10 based on the obtained data and a site is displayed on the display 12 by the OSD unit 10.

Here, the site to be accessed is preferably an earthquake-related site of Twitter (registered trademark) that is one of SNSs (Social Network Services). In Twitter, postings from users are displayed in a chronological order and earthquake-related detailed information is available on an earthquake-related site. In this case, the URL of the earthquake-related site of Twitter may be registered as the URL.

Note that the site to be accessed may be, for example, an SNS other than Twitter (e.g. Facebook (registered trademark)) or may be an earthquake-related site of the Meteorological Agency. At the earthquake-related site of the Meteorological Agency, highly reliable formal earthquake-related information is available.

As for the URL, a URL stored in the flash memory 16 at the time of shipment from a factory may be used or firmware may be updated and the URL may be updated by downloading firmware including a new URL from the Internet 18.

Further, the user may enter a URL on an OSD screen displayed on the display 12 using the remote controller and register the entered URL in the flash memory 16.

Further, the display of the site may be made by displaying a site screen on a broadcast screen in a superimposition manner and the site screen may be displayed in an area smaller than the broadcast screen.

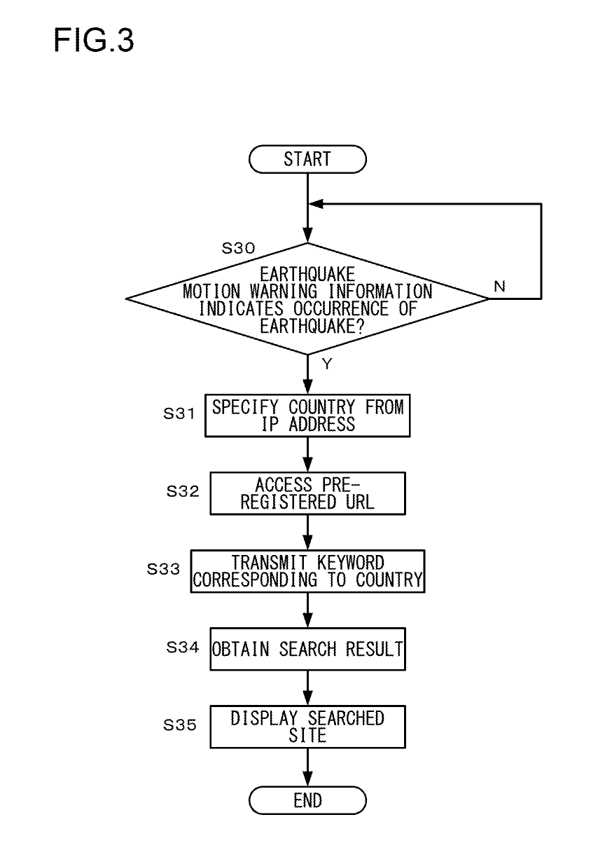

Next, another embodiment of the earthquake detection process of the digital television 100 according to the present invention is described using a flow chart of FIG. 3.

First, in Step S30, the microcomputer 15 determines whether or not the earthquake motion warning information included in the AC signal extracted in the AC demodulator/decoder 13 indicates the occurrence of an earthquake, and determination is continued if no earthquake has occurred (N in Step S30) while a transition is made to Step S31 if an earthquake has occurred (Y in Step S30).

In Step S31, the microcomputer 15 specifies a country from an IP address allotted to the digital television 100.

Subsequently, in Step S32, the network I/F 17 accesses the server 19 of the URL pre-registered in the flash memory 16 in accordance with an instruction of the microcomputer 15. Here, it is preferable to access, for example, Twitter. Then, in Step S33, the microcomputer 15 transmits a search keyword corresponding to the country specified in Step S31 to the server 19 via the network I/F 17. Here, the search keyword may be, for example, a country name and an earthquake-related word.

Then, in Step S34, the server 19 searches a site based on the transmitted search keyword and transmits a search result to the microcomputer 15 via the network I/F 17, and the microcomputer 15 obtains the search result.

Then, in Step S35, the microcomputer 15 instructs the OSD unit 10 based on the obtained search result and the searched site is displayed on the display 12 by the OSD unit 10.

Since the country where the digital television is installed is automatically detected and the earthquake-related site of this country is displayed in this way, convenience is high.

As described above, according to the present invention, when an earthquake occurs and earthquake motion warning information indicating the occurrence of the earthquake is received from terrestrial digital broadcast, an earthquake-related site is automatically displayed by Internet communication. Thus, a user can obtain earthquake-related detailed information in a short time without requiring a special apparatus outside the digital television.

The embodiments of the present invention have been described above. Various changes can be made in the embodiment without departing from the scope of the gist of the present invention.

For example, what is received by digital broadcast is not limited to earthquake motion warning information and may be disaster warning information on typhoon, tsunami, heavy rain, fire disaster or the like or may be other emergency warning information without being limited to disasters.

Further, the digital broadcast receiving apparatus of the present invention is not limited to the digital television and may be applied to a Blu-ray Disc recorder, a DVD recorder, an HDD recorder, a set top box or the like.

What is claimed is:

1. A digital broadcast receiving apparatus, comprising:
an emergency warning information obtaining unit for receiving a digital broadcast signal and extracting and obtaining emergency warning information from the received digital broadcast signal;
a network communication unit for obtaining information on a site related to the emergency by network communication when the emergency warning information obtained by the emergency warning information obtaining unit indicates the occurrence of an emergency; and
a display signal generation unit for generating a display signal based on the information on the site obtained by the network communication unit and outputting the display signal to a display unit.

2. The digital broadcast receiving apparatus according to claim 1, wherein the emergency warning information is disaster warning information.

3. The digital broadcast receiving apparatus according to claim 2, wherein the disaster warning information is earthquake motion warning information.

4. The digital broadcast receiving apparatus according to claim 1, wherein the information on the site is information on an SNS (Social Network Service).

5. The digital broadcast receiving apparatus according to claim 4, wherein the information on the SNS is information on Twitter (registered trademark).

6. The digital broadcast receiving apparatus according to claim 1, further comprising an updating unit for updating firmware and a URL (Uniform Resource Locator) by downloading firmware including a URL from a network, wherein:
the network communication unit obtains the information on the site related to the emergency by accessing the updated URL when the emergency warning information obtained by the emergency warning information obtaining unit indicates the occurrence of the emergency.

7. The digital broadcast receiving apparatus according to claim 1, further comprising an area detection unit for detecting an area where the apparatus is installed when the emergency warning information obtained by the emergency warning information obtaining unit indicates the occurrence of the emergency, wherein:
the network communication unit accesses a pre-registered site, transmits a keyword corresponding to the detected area for search and obtains searched information on a site related to the emergency when the emergency warning information obtained by the emergency warning information obtaining unit indicates the occurrence of the emergency.
